(19) United States
(12) Patent Application Publication
(10) Pub. No.: US 2010/0326937 A1
(43) Pub. Date: Dec. 30, 2010

(54) Combined Metal Sheets with Strengthened Structure of Combined Racks

(76) Inventor: Tsong-Yow Lin, Ta Tou Hsiang (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 12/493,289

(22) Filed: Jun. 29, 2009

(51) Int. Cl. A47F 5/00; B32B 3/02

(52) U.S. Cl. 211/135; 211/153; 428/600; 428/599

(57) ABSTRACT

A metal sheet comprises a main body forming with at least two opposite mounted portions and two opposite strengthened portions on peripheries thereof; wherein each mounted portion includes an initiating terminal end connected to the main body, a finishing terminal end contiguously extending from the initiating terminal end and a space surrounded by the mounted portion between the initiating and finishing terminal ends; wherein a center line X is defined by connecting center points of cross-sections of various transverse positions of each mounted portion and provided inside of the space; wherein the finishing terminal ends of the two opposite mounted portions define a first distance, and the center lines X of the two opposite mounted portions define a second distance, with the first distance being smaller than the second distance.

### BACKGROUND OF THE INVENTION

1. Field of the Invention

The present invention relates to combined metal sheets with strengthened structure of combined racks, more particularity, relates to combined metal sheets with strengthened structure of combined racks, with each metal sheet having two opposite mounted portion and two opposite strengthened portions formed on peripheries of main body thereof for achieving a great strengthened effect.

2. Description of the Related Art

Referring to Taiwan patent No. M342796, it discloses that conventional combined racks include a main body, two rods and a bearing plate. The two rods are respectively fixed to two sides of the main body, and two ends of each rod are respectively engaged with the main body via fasteners. Peripheries of front and rear of the bearing plate are rolled downward and inward as to form hooking portions which are adapted to clasp the rods as to attach the bearing plate to the two rods. Further, the bearing plate has a certain thickness for supporting items disposed thereon. However, the thicker the thickness of the bearing plate, the more production costs of the combined racks. Therefore, production costs will be reflected in prices.

### SUMMARY OF THE INVENTION

The present invention is directed at providing metal sheets with strengthened structures and combined racks which consist of the metal sheets. Each metal sheet which is thin and lightweight includes mounted portions and strengthened portions as to achieve greater structure strength effect. And the thin and lightweight metal sheets can reduce production costs of the combined racks.

Other objectives, advantages, and features of the invention will become more apparent from the following detailed description when taken in conjunction with the accompanying drawings.

### BRIEF DESCRIPTION OF THE DRAWINGS

FIG. 1 is a perspective view of a metal sheet with strengthened structure according to the first embodiment of the present invention.

FIG. 2 is a cross-sectional view taken along line 2-2 in FIG. 1.

FIG. 3 is a partial, enlarged view of the metal sheet with strengthened structure shown in FIG. 2.

FIG. 4 is a cross-sectional view taken along line 4-4 in FIG. 1.

FIG. 5 is a partial, enlarged view of the metal sheet with strengthened structure shown in FIG. 4.

FIG. 6 is a perspective view of a metal sheet with strengthened structure according to the second embodiment of the present invention.

FIG. 7 is a perspective view of combined racks, which consists of the metal sheets discussed above, according to the first embodiment of the present invention.

FIG. 8 is an exploded view of the combined racks shown in FIG. 7.

FIG. 9 is a front view of the combined racks shown in FIG. 7.

FIG. 10 is a partial, enlarged view of the combined racks shown in FIG. 9.

FIG. 11 is a side view of the combined racks shown in FIG. 7.

FIG. 12 is a partial, enlarged view of the combined racks shown in FIG. 11.

FIG. 13 is a rear view of the combined racks shown in FIG. 7.

FIG. 14 is a partial, enlarged view of the combined racks shown in FIG. 13.

FIG. 15 is an exploded view of combined racks, which consists of the metal sheets discussed above, according to the second embodiment of the present invention.

FIG. 16 is a cross-sectional view of the combined racks shown in FIG. 15.

FIG. 17 is a partial, enlarged view of the combined racks shown in FIG. 16.

FIG. 18 is a perspective view of combined racks, which consists of the metal sheets discussed above, according to the third embodiment of the present invention.

FIG. 19 is an exploded view of the combined racks shown in FIG. 18.

FIG. 20 is a cross-sectional view of the combined racks shown in FIG. 18.

FIG. 21 is a partial, enlarged view of the combined racks shown in FIG. 20.

### DETAILED DESCRIPTION OF THE PREFERRED EMBODIMENT

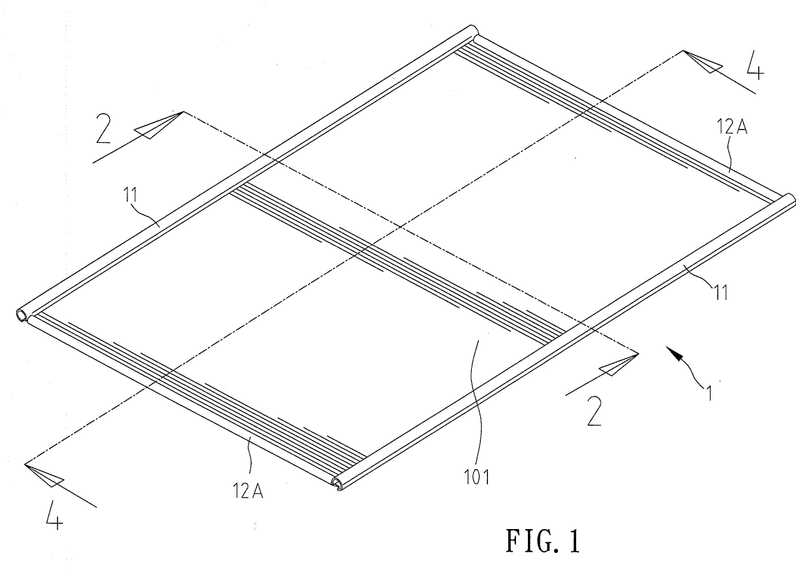

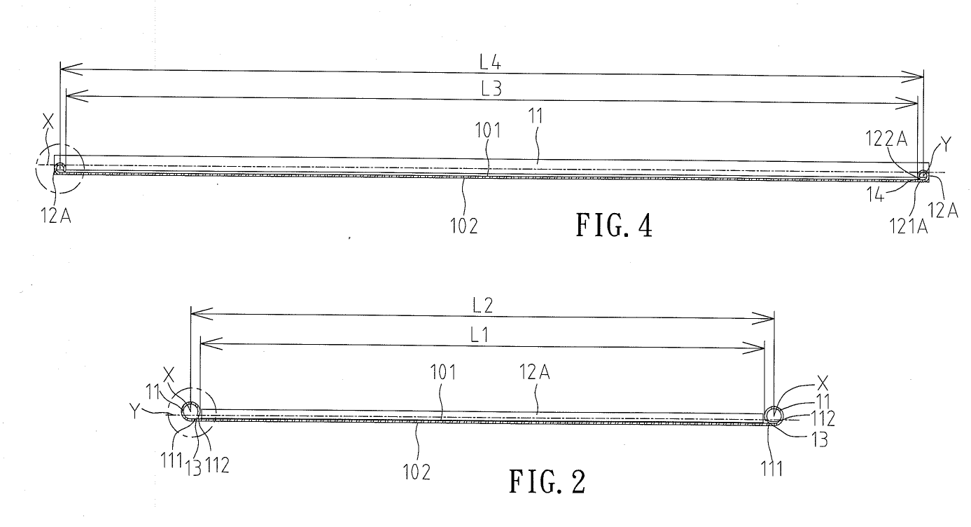

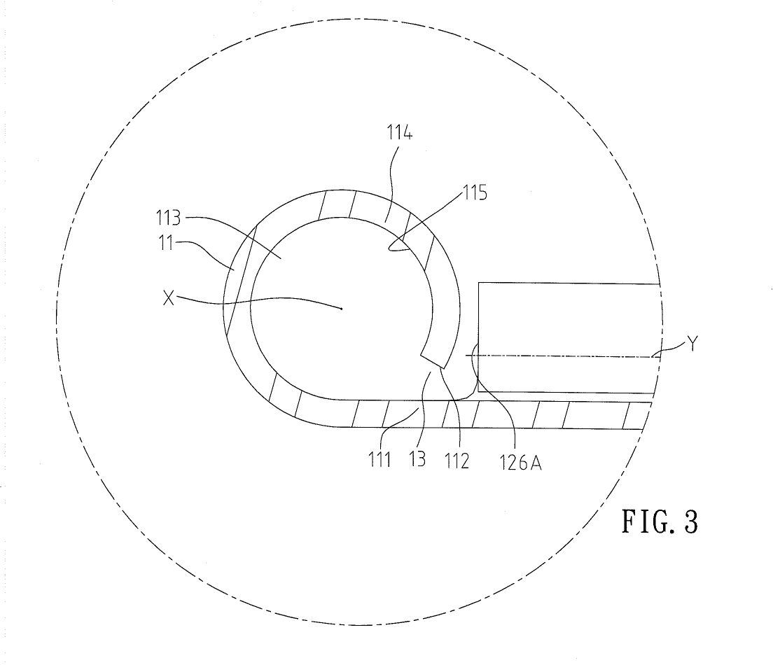

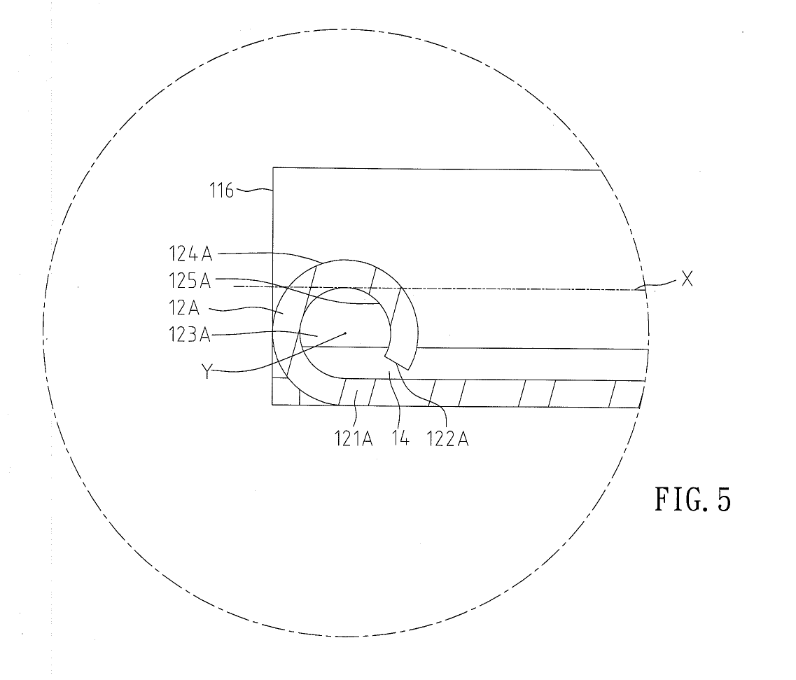

Referring to FIGS. 1 through 5, they show a metal sheet with strengthened structure in accordance with a first embodiment of the present invention. The metal sheet includes a main body 1 which forms with two opposite mounted portions 11 and two opposite strengthened portions 12. Each mounted portion 11 includes an initiating terminal end 111 connected to the main body 1, a finishing terminal end 112 contiguously extending from the initiating terminal end 111 and a space 113 surrounded by the mounted portion 11 between the initiating 111 and finishing 112 terminal ends. A center line X is defined by connecting center points of cross-sections of various transverse positions of each mounted portion 11 and provided inside of the space 113. And the finishing terminal ends 112 of the two opposite mounted portions 11 define a first distance L1, and the center lines X of the two opposite mounted portions 11 define a second distance L2. In this case, the first distance L1 is smaller than the second distance L2.

Each mounted portion 11 is roll-shaped and in this case, the mounted portion 11 is rolled round-shaped. A gap 13 is formed between each finishing terminal end 112 and the related initiating terminal end 111, and an arc (not numbered) defined by the finishing terminal end 112 and the initiating terminal end 111. The size of the arc is adjustable and depended on the gap 13, and the arc includes an interior angle between the related finishing terminal end 112 and the related initiating terminal end 111. The interior angle is larger than 180 degrees. In this embodiment, range of the interior angle is preferably between 270 degrees and 360 degrees. An outer surface 114 and an inner surface 115 are respectively defined on each mounted portion 11, and the inner surface 115 surrounds the related space 13. Two end surfaces 116 are respectively defined at two ends of each mounted portion 11.

The main body 1 has first 101 and second 102 surfaces. A horizontal position of each mounted portion 11 is higher than that of the first surface 101 of the main body 1. Further, a horizontal position of each strengthened portion 12A is higher than that of the first surface 101 of the main body 1. The metal sheet which includes the rolled round-shaped mounted portions 11 is not easy to be bent by an external force as to achieve greater structure strength effect.

Each strengthened portion 12A includes an initiating terminal end 121A connected to the main body 1, a finishing terminal end 122A contiguously extending from the initiating terminal end 121A and a space 123A surrounded by the strengthened portion 12A between the initiating 121A and finishing 122A terminal ends. A center line Y is defined by connecting center points of cross-sections of various transverse positions of each strengthened portion 12A and provided inside of the space 123A. And the finishing terminal ends 122A of the two opposite strengthened portions 12A define a third distance L3, and the center lines Y of the two opposite strengthened portions 12A define a fourth distance L4. In this case, the third distance L3 is smaller than the fourth distance L4.

Each strengthened portion 12A is roll-shaped and in this case, the strengthened portion 12A is rolled round-shaped. A gap 14 is formed between each finishing terminal end 122A and the related initiating terminal end 121A, and an arc (not numbered) defined by the finishing terminal end 122A and the initiating terminal end 121A. The size of the arc is adjustable and depended on the gap 14, and the arc includes an interior angle between the related finishing terminal end 122A and the related initiating terminal end 121A. The interior angle is larger than 180 degrees. In this embodiment, range of the interior angle is preferably between 270 degrees and 360 degrees. An outer surface 124A and an inner surface 125A are respectively defined on each strengthened portion 12A, and the inner surface 125A surrounds the related space 14. Two end surfaces 126A are respectively defined at two ends of each strengthened portion 12A.

The two end surfaces 126A respectively extend toward and are abutted against the outer surfaces 114 of the two mounted portions 11. A horizontal position of each strengthened portion 12A is lower than that of each mounted portion 11.

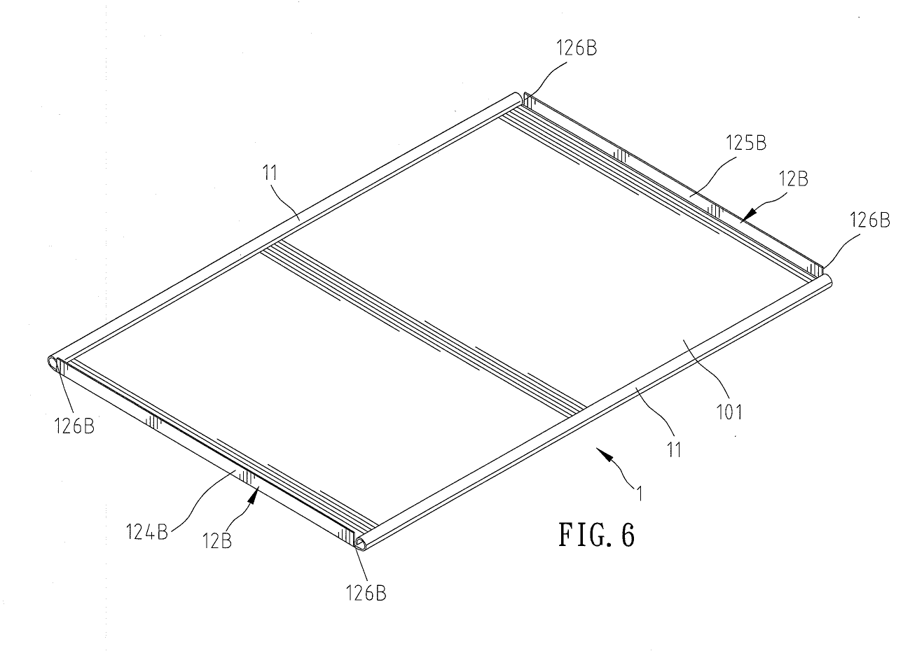

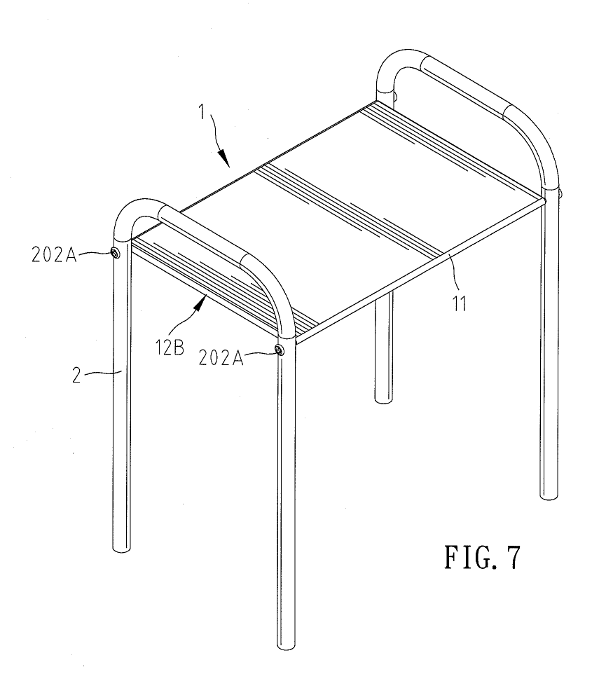

Referring to FIG. 6, it shows a metal sheet with strengthened structure in accordance with a second embodiment of the present invention similar to the first embodiment except that two opposite strengthened portions 12B replace the two opposite strengthened portions 12A. Each strengthened portion 12B is bent toward the first surface 101 of the main body 1 and being flat. An outer surface 124B and an inner surface 125B are respectively defined on each strengthened portion 12B, and the inner surfaces 125B of the two strengthened portions 12B face to each other. Two end surfaces 126B are respectively defined at two ends of each strengthened portion 12B and face toward the outer surfaces 114 of the two mounted portions 11.

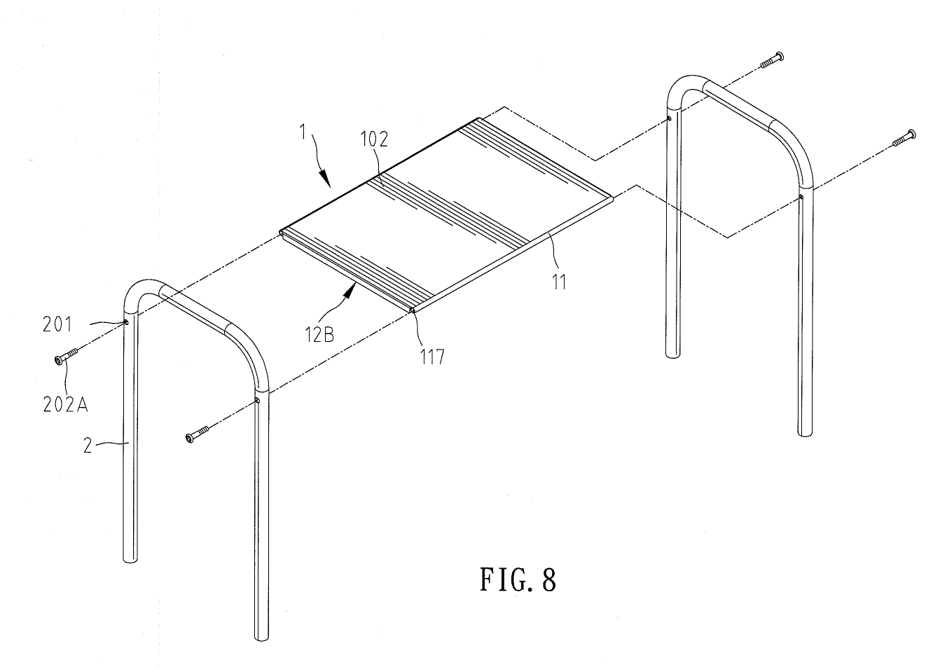

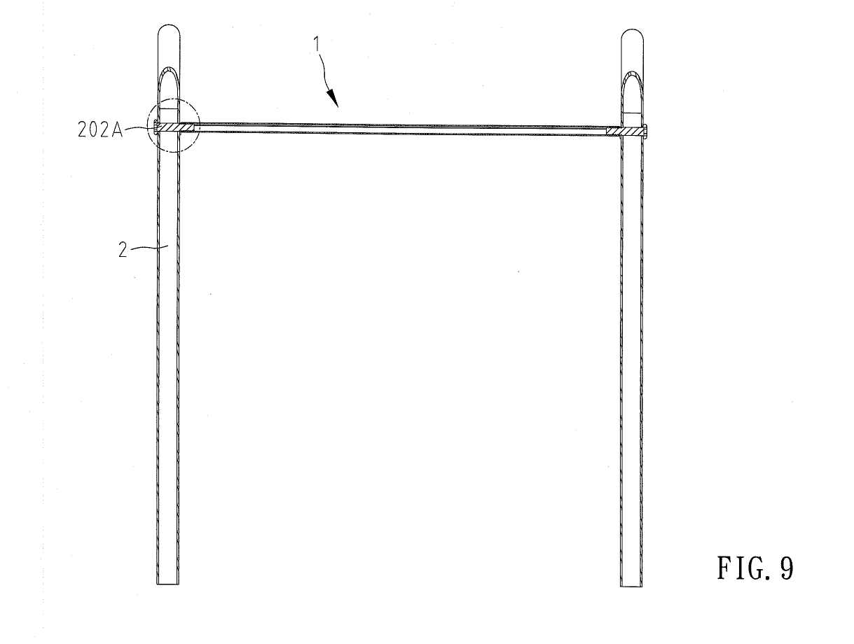

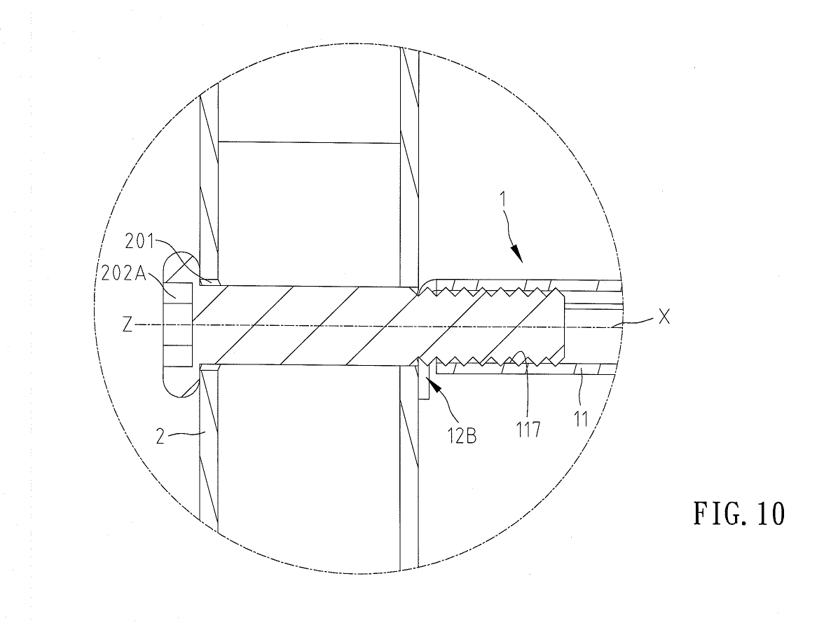

Referring to FIGS. 7 through 10, they show combined racks, which consist of the metal sheets discussed above, in accordance with a first embodiment of the present invention. The combined racks include two frames 2 and the main body 1. Each frame 2 is preferably U-shaped and has two legs (not numbered) standing on the ground and a body portion (not numbered) defined between the two legs. Two opposite through-holes 201 are formed on the two legs of each frame 2 adjacent to two ends of the body portion of each frame 2. Two fasteners 202A are provided at the through-holes 201 respectively and adapted to engage each frame 2 with the main body 1. In this case, each fastener 202A is in form of bolt, preferably.

The mounted portions 11 of the main body 1 which are defined at two opposite sides of the main body 1 correspond to the through-holes 201 respectively. Two threaded portions 117 are formed at the ends of each mounted portion 11 and adapted to engage the main body 1 with the frame 2. And the strengthened portions 12B of the main body 1 is preferably flat and bent from the main body 1.

The two fasteners 202A are engaged the through-holes 201 with the threaded portions 117 of the mounted portions 11 respectively. A center line Z is defined through each fastener 202A and collinear with the center line X of each mounted portion 11. In this embodiment, the threaded portions 117 are able to be formed by tapping on the mounted portions 11 or embedded nuts into the mounted portions 11.

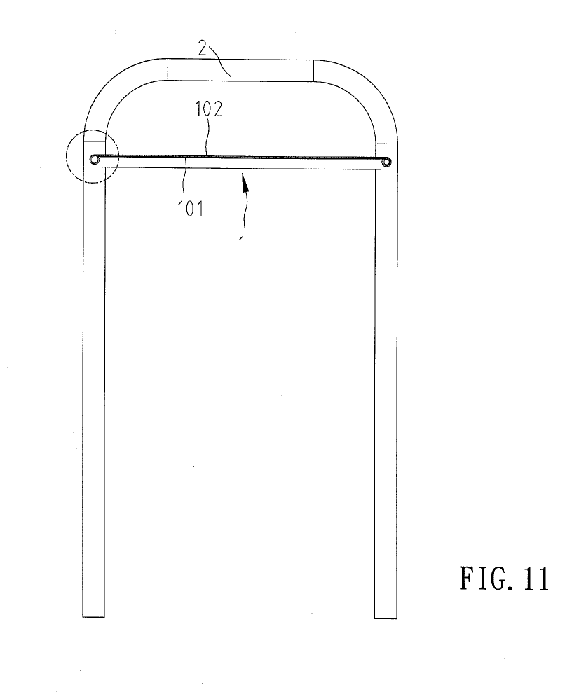

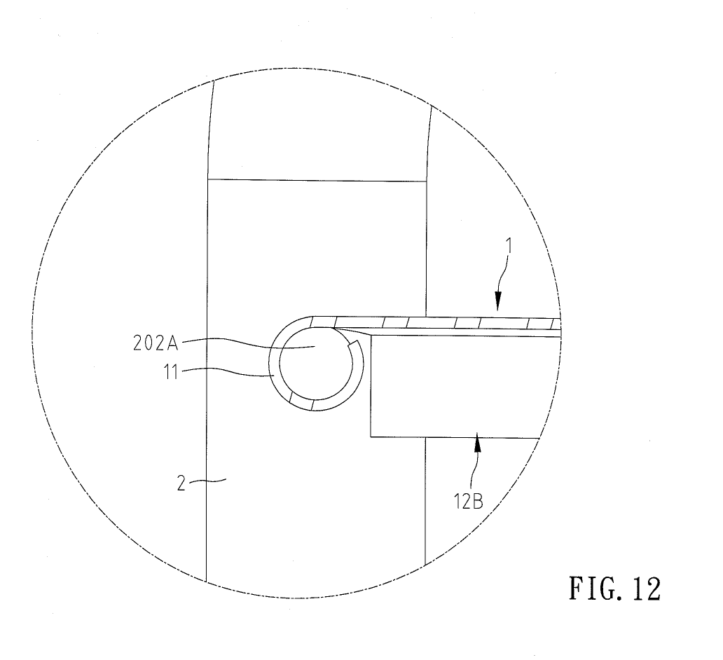

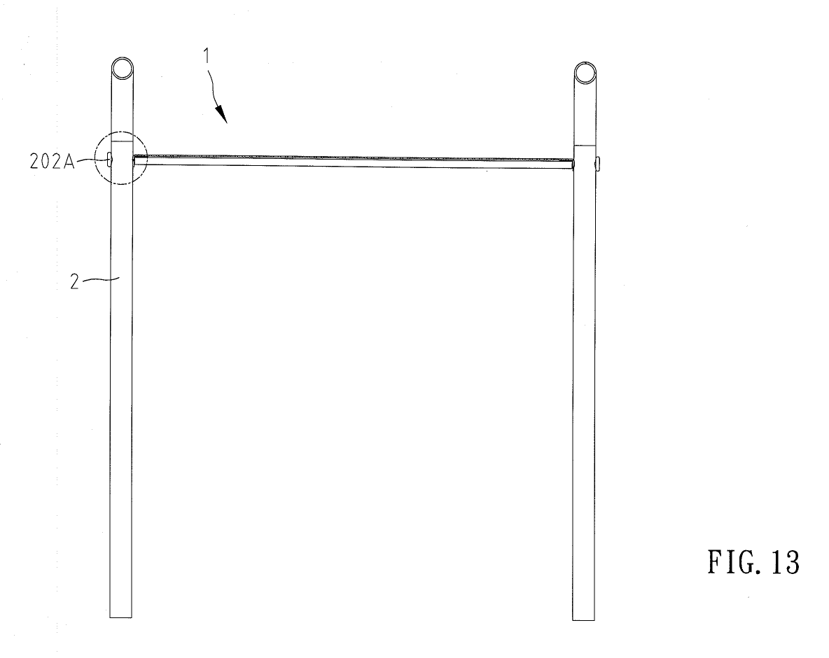

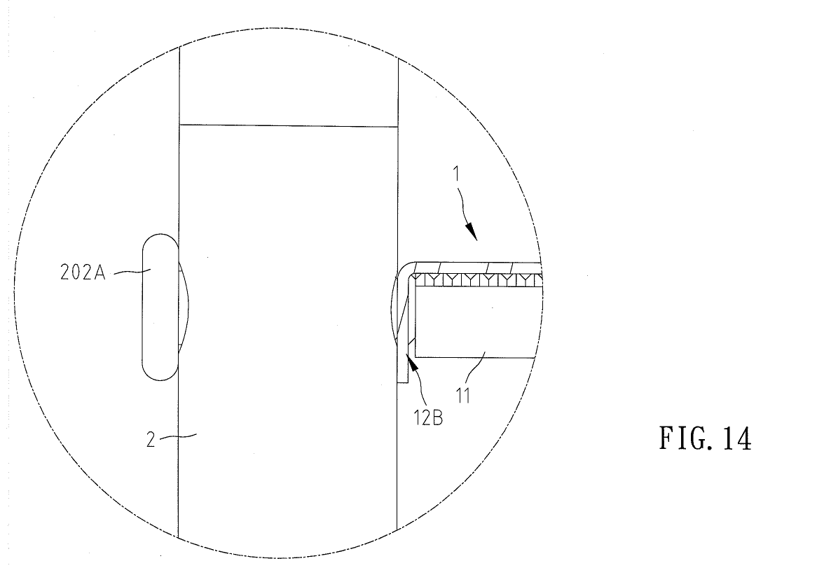

Referring to FIGS. 11 through 14 at the same time, the mounted portions 11 are combined with the fasteners 202A in a screwing manner. The threaded portions 117 are directly formed on the mounted portions 11, and it can eliminate redundant design of disposing fittings inside of the mounted portions 11 for engaging with the fasteners 202A which is implemented in a traditional manner. The bent mounted portions 11 and strengthened portions 12B are provided to achieve greater structure strength effect. Therefore, even if the main body 1 is made of thin metal plate, it still has a certain structural strength.

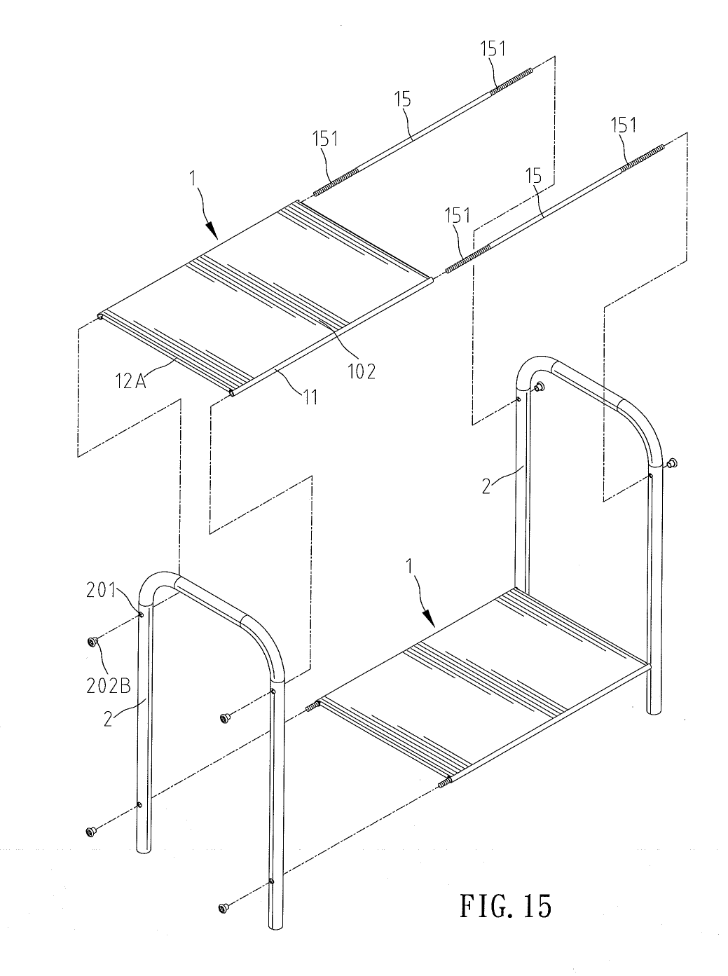

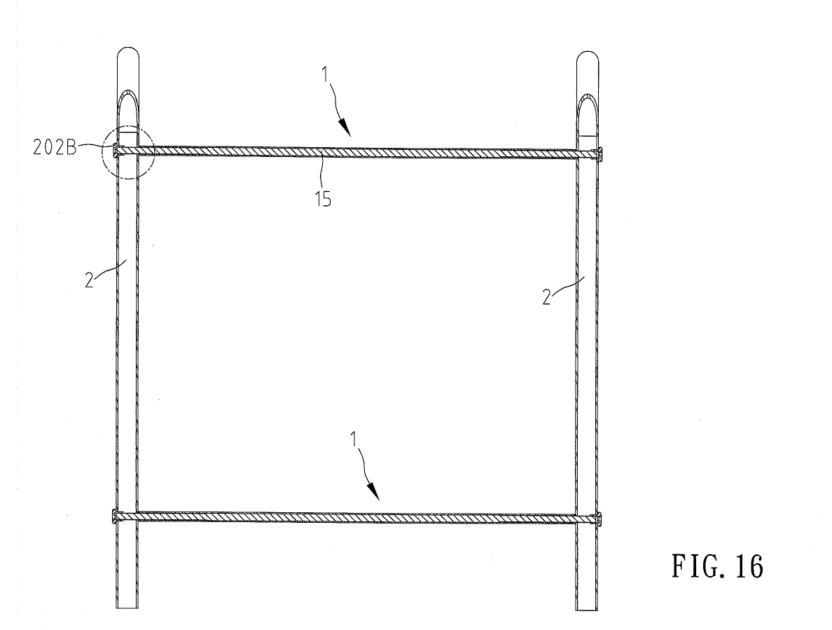

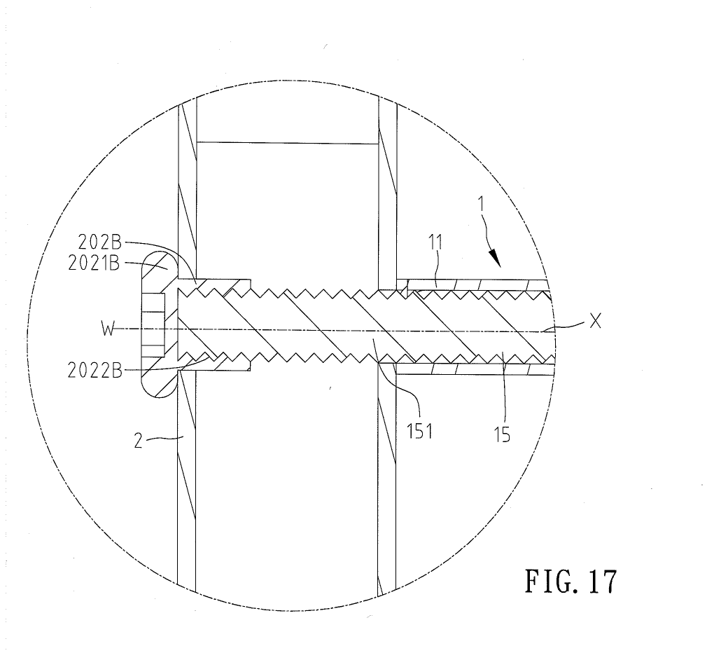

Referring to FIGS. 15 through 17, they show combined racks, which consist of the metal sheets discussed above, in accordance with a second embodiment of the present invention similar to the first embodiment of the combined racks as shown in FIGS. 7 through 14, except for several features. Firstly, two fasteners 202B replace the two fasteners 202A. Each fastener 202B includes a head 2021B and a mount 2022B having internal threads. A center line W is defined through each fastener 202B and collinear with the center line X of each mounted portion 11.

Secondly, one screw rods 15 is provided to insert through each mounted portion 11 and includes two threaded portions 151 formed at two ends thereof. And the threaded portions 151 are disposed at the two ends of each mounted portion 11 and inserted through the through-holes 201 of the frame 2 as to engage with the fasteners 202B. Each head 2021B is blocked on the frame 2 and each mount 2022B is engaged with the related threaded portion 151 of the screw rod 15 as to attach the main body 1 to the frame 2.

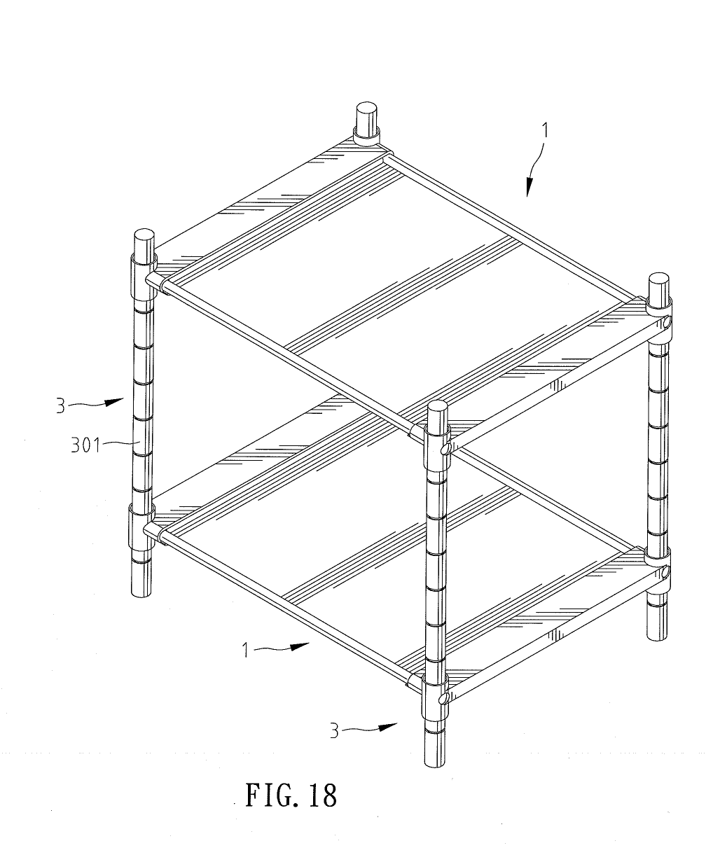

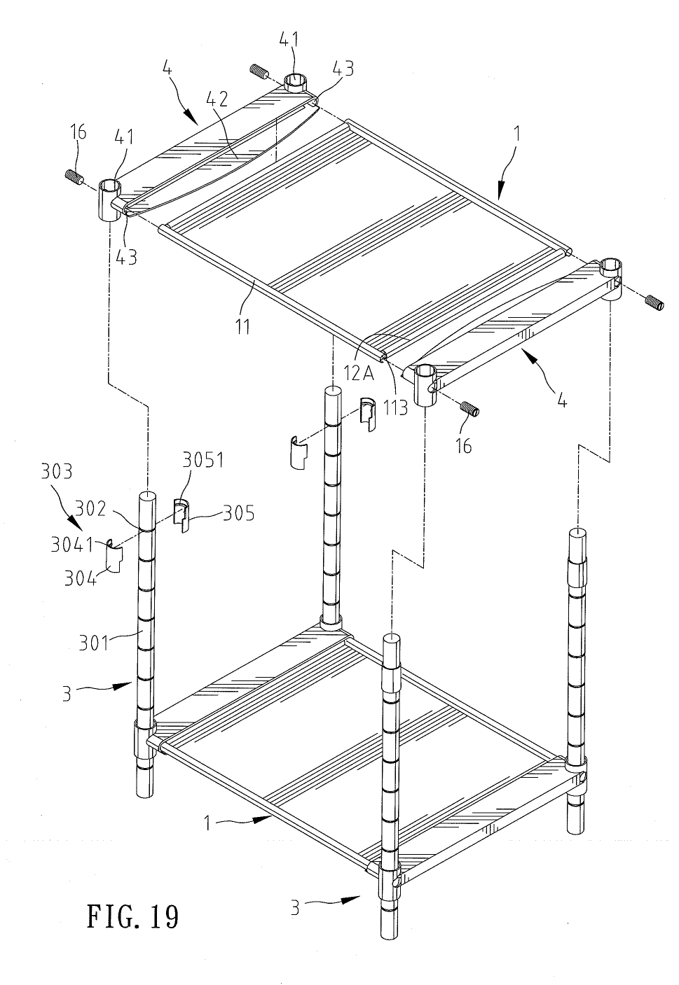

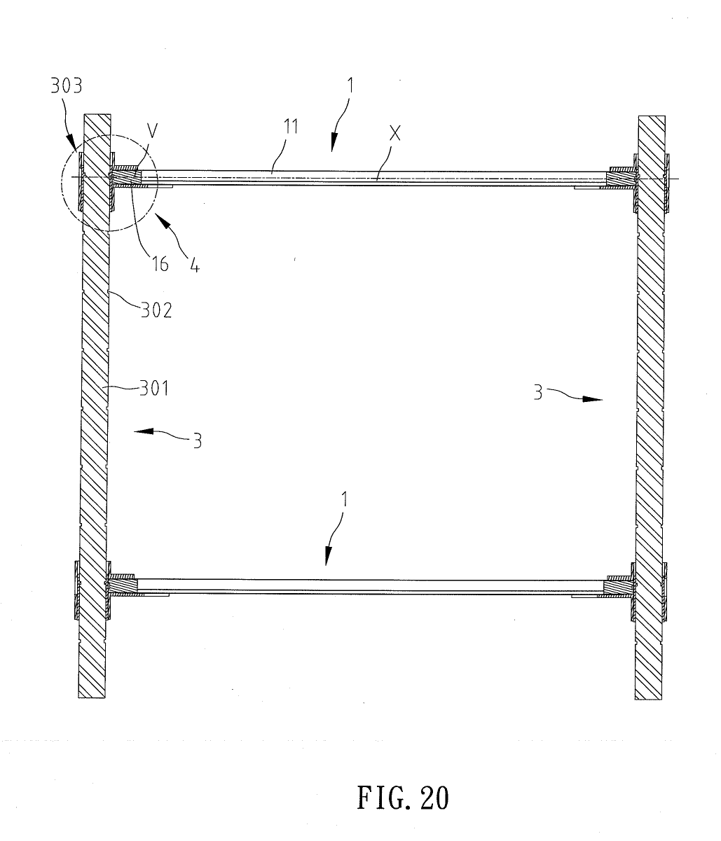

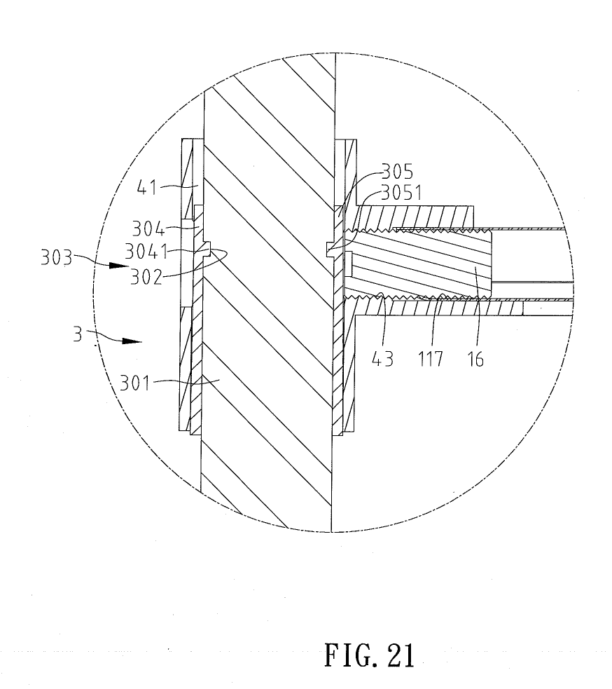

Referring to FIGS. 18 through 21, they show combined racks, which consist of the metal sheets discussed above, in accordance with a third embodiment of the present invention similar to the first embodiment of the combined racks as shown in FIGS. 7 through 14, except for several features. Firstly, two sets of frames 3 replace the two frames 2, and each set of frames 3 includes two posts 301, numbers of annular grooves 302 formed on each post 301 and a collar set 303 provided on each post 301. The annular grooves 302 are defined at various horizontal positions on each post 301. The collar set 303 consists of first 304 and second 305 halves which are opposite to each other and able to join together. Flanges 3041 and 3051 are respectively formed on inner peripheries of the first 304 and second 305 halves and correspond to one of the annular grooves 302. The combined collar set 303 has top end and bottom end, and a diameter of the top end is smaller than a diameter of the bottom end.

Secondly, two joint assemblies 4 are respectively installed to the two sides of the main body 1, and each joint assembly 4 includes two first mounts 41 longitudinally provided at two ends thereof and a second mount 42 transversely between the first mounts 41. Two coupled holes 43 are formed between two end of the second mount 42 and the adjacent first mounts 41. Each coupled hole 43 is in form of threaded hole and communicates the first 41 and second 42 mounts to each other.

Thirdly, two fastening elements 16 are provided at the two ends of each mounted portion 11 and a center line V is defined through each fastening element 16 and collinear with the center line X of each mounted portion 11. Two ends of each fastening element 16 are respectively engaged with the threaded portion 117 of the related end of the mounted portion 11 and the related coupled hole 43 of the joint assembly 4. The two second mounts 42 are respectively mounted onto the two strengthened portions 12A. And then, the first mounts 41 are mounted onto the posts 301 and the collar sets 303. Because of the larger diameter of each bottom end of the collar set 303, the first mounts 41 are blocked by the collar sets 303 as to attach the frame 3 to the main body 1.

While several embodiments of the invention have been shown and described, it will be apparent to those skilled in the art that modifications may be made therein without departing from the scope and spirit of the present invention.

What is claimed is:

1. A metal sheet comprising:
a main body forming with at least two opposite mounted portions and two opposite strengthened portions on peripheries thereof;
wherein each mounted portion includes an initiating terminal end connected to the main body, a finishing terminal end contiguously extending from the initiating terminal end and a space surrounded by the mounted portion between the initiating and finishing terminal ends;
wherein a center line X is defined by connecting center points of cross-sections of various transverse positions of each mounted portion and provided inside of the space;
wherein the finishing terminal ends of the two opposite mounted portions define a first distance, and the center lines X of the two opposite mounted portions define a second distance, with the first distance being smaller than the second distance.

2. The metal sheet as claimed in claim 1 wherein each mounted portion is rolled round-shaped and defines an arc by the finishing terminal end and the initiating terminal end; wherein size of the arc includes an interior angle between the finishing terminal end and the initiating terminal end, with the interior angle being larger than 180 degrees.

3. The metal sheet as claimed in claim 1 further comprising an outer surface defined on each mounted portion 11 and two end surfaces are respectively defined at two ends of each strengthened portion; wherein the two end surfaces respectively extend toward and are abutted against the outer surfaces of the two mounted portions.

4. The metal sheet as claimed in claim 3 wherein each strengthened portion includes an initiating terminal end connected to the main body, a finishing terminal end contiguously extending from the initiating terminal end and a space surrounded by the strengthened portion between the initiating and finishing terminal ends; wherein a center line Y is defined by connecting center points of cross-sections of various transverse positions of each strengthened portion and provided inside of the space; wherein the finishing terminal ends of the two opposite strengthened portions define a third distance, and the center lines Y of the two opposite strengthened portions define a fourth distance, with the third distance being smaller than the fourth distance.

5. The metal sheet as claimed in claim 4 wherein each strengthened portion is rolled round-shaped and defines an arc by the finishing terminal end and the initiating terminal end; wherein size of the arc includes an interior angle between the finishing terminal end and the initiating terminal end, with the interior angle being larger than 180 degrees.

6. The metal sheet as claimed in claim 1 wherein each mounted portion is rolled round-shaped and each strengthened portion is rolled round-shaped, with a horizontal position of each strengthened portion being lower than that of each mounted portion relative to a first surface of the main body.

7. The metal sheet as claimed in claim 1 wherein each strengthened portion is bent toward a first surface of the main body and being flat.

8. A combined rack comprising:
numbers of metal sheets, each metal sheet includes a main body forming with at least two opposite mounted portions and two opposite strengthened portions on peripheries thereof;
wherein each mounted portion includes an initiating terminal end connected to the main body, a finishing terminal end contiguously extending from the initiating terminal end and a space surrounded by the mounted portion between the initiating and finishing terminal ends;
wherein a center line X is defined by connecting center points of cross-sections of various transverse positions of each mounted portion and provided inside of the space;
wherein the finishing terminal ends of the two opposite mounted portions define a first distance, and the center lines X of the two opposite mounted portions define a second distance, with the first distance being smaller than the second distance; and
two frames, each frame includes two opposite through-holes formed thereon and two fasteners provided at the through-holes respectively and adapted to engage each frame with the two ends of each mounted portion of the main body;
wherein a center line Z; W is defined through each fastener and collinear with the center line X of each mounted portion.

9. The combined rack as claimed in claim 8 further comprising two threaded portions formed at the two ends of each mounted portion, with the two fasteners engaged the through-holes with the threaded portions of the mounted portions respectively.

10. The combined rack as claimed in claim 8 further comprising one screw rods provided to insert through each mounted portion and includes two threaded portions formed at two ends thereof; wherein the threaded portions are disposed at the two ends of each mounted portion and inserted through the through-holes of the frame as to engage with the fasteners.

11. The combined rack as claimed in claim 10 wherein each fastener has a head blocked on the frame and a mount engaged with the related threaded portion of the screw rod as to attach the main body to the frame.

12. The combined rack as claimed in claim 8 wherein each mounted portion is rolled round-shaped and defines an arc by the finishing terminal end and the initiating terminal end; wherein size of the arc includes an interior angle between the finishing terminal end and the initiating terminal end, with the interior angle being larger than 180 degrees.

13. The combined rack as claimed in claim 8 further comprising an outer surface defined on each mounted portion and two end surfaces are respectively defined at two ends of each strengthened portion; wherein the two end surfaces respectively extend toward and are abutted against the outer surfaces of the two mounted portions.

14. The combined rack as claimed in claim 13 wherein each strengthened portion includes an initiating terminal end connected to the main body, a finishing terminal end contiguously extending from the initiating terminal end and a space surrounded by the strengthened portion between the initiating and finishing terminal ends; wherein a center line Y is defined by connecting center points of cross-sections of various transverse positions of each strengthened portion and provided inside of the space; wherein the finishing terminal ends of the two opposite strengthened portions define a third distance, and the center lines Y of the two opposite strengthened portions define a fourth distance, with the third distance being smaller than the fourth distance.

15. The combined rack as claimed in claim 14 wherein each strengthened portion is rolled round-shaped and defines an arc by the finishing terminal end and the initiating terminal end; wherein size of the arc includes an interior angle between the finishing terminal end and the initiating terminal end, with the interior angle being larger than 180 degrees.

16. The combined rack as claimed in claim 8 wherein each mounted portion is rolled round-shaped and each strengthened portion is rolled round-shaped, with a horizontal position of each strengthened portion being lower than that of each mounted portion relative to a first surface of the main body.

17. The combined rack as claimed in claim 8 wherein each strengthened portion is bent toward a first surface of the main body and being flat.

18. A combined rack comprising:
numbers of metal sheets, each metal sheet includes a main body forming with at least two opposite mounted portions and two opposite strengthened portions on peripheries thereof;
wherein each mounted portion includes an initiating terminal end connected to the main body, a finishing terminal end contiguously extending from the initiating terminal end and a space surrounded by the mounted portion between the initiating and finishing terminal ends;
wherein a center line X is defined by connecting center points of cross-sections of various transverse positions of each mounted portion and provided inside of the space;
wherein the finishing terminal ends of the two opposite mounted portions define a first distance, and the center lines X of the two opposite mounted portions define a second distance, with the first distance being smaller than the second distance;
two sets of frames;
at least two of fastening elements provided at the two ends of each mounted portion and a center line V is defined through each fastening element and collinear with the center line X of each mounted portion, with an end of each fastening element engaged with the threaded portion of the related end of the mounted portion; and
two joint assemblies, each joint assembly including two first mounts longitudinally provided at two ends thereof and two coupled holes transversely formed adjacent to the two first mounts respectively, with another end of each fastening element engaged with each coupled hole, with the main body attached to the joint assemblies and the first mount of each joint assembly mounted onto the frame.

19. The combined rack as claimed in claim 18 wherein each set of frames includes two posts and a collar set provided on each post, with the collar set having top end and bottom end, and a diameter of the top end is smaller than a diameter of the bottom end.

20. The combined rack as claimed in claim 19 wherein the collar set consists of first and second halves which are opposite to each other and able to join together.

21. The combined rack as claimed in claim 20 further comprising numbers of annular grooves formed on each post and defined at various horizontal positions on each post and flanges are respectively formed on inner peripheries of the first and second halves and correspond to one of the annular grooves.

22. The combined rack as claimed in claim 18 further comprising a second mount extending transversely between the first mounts, with the two coupled holes transversely formed between two end of the second mount and the adjacent first mounts, and with the two second mounts respectively mounted onto the two strengthened portions.

23. The combined rack as claimed in claim 18 wherein each mounted portion is rolled round-shaped and defines an arc by the finishing terminal end and the initiating terminal end; wherein size of the arc includes an interior angle between the finishing terminal end and the initiating terminal end, with the interior angle being larger than 180 degrees.

24. The combined rack as claimed in claim 18 further comprising an outer surface defined on each mounted portion and two end surfaces are respectively defined at two ends of each strengthened portion; wherein the two end surfaces respectively extend toward and are abutted against the outer surfaces of the two mounted portions.

25. The combined rack as claimed in claim 24 wherein each strengthened portion includes an initiating terminal end connected to the main body, a finishing terminal end contiguously extending from the initiating terminal end and a space surrounded by the strengthened portion between the initiating and finishing terminal ends; wherein a center line Y is defined by connecting center points of cross-sections of various transverse positions of each strengthened portion and provided inside of the space; wherein the finishing terminal ends of the two opposite strengthened portions define a third distance, and the center lines Y of the two opposite strengthened portions define a fourth distance, with the third distance being smaller than the fourth distance.

26. The combined rack as claimed in claim 25 wherein each strengthened portion is rolled round-shaped and defines an arc by the finishing terminal end and the initiating terminal end; wherein size of the arc includes an interior angle between the finishing terminal end and the initiating terminal end, with the interior angle being larger than 180 degrees.

27. The combined rack as claimed in claim 18 wherein each mounted portion is rolled round-shaped and each strengthened portion is rolled round-shaped, with a horizontal position of each strengthened portion being lower than that of each mounted portion relative to a first surface of the main body.

28. The combined rack as claimed in claim 18 wherein each strengthened portion is bent toward a first surface of the main body and being flat.
